(19) United States
(12) Patent Application Publication
(10) Pub. No.: US 2011/0014391 A1
(43) Pub. Date: Jan. 20, 2011

(54) METHODS OF SLIDE COATING TWO OR MORE FLUIDS

(76) Inventors: Robert A. Yapel, Oakdale, MN (US); Thomas J. Ludemann, Maplewood, MN (US); Brent A. Hedding, Hudson, WI (US); Richard J. Pokorny, Maplewood, MN (US); John P. Baetzold, North St. Paul, MN (US); Daniel V. Norton, St. Paul, MN (US); Chris J. Tanley, Woodbury, MN (US)

Correspondence Address: 3M INNOVATIVE PROPERTIES COMPANY, PO BOX 33427, ST. PAUL, MN, 55133-3427, US

(21) Appl. No.: 12/934,304

(22) PCT Filed: Mar. 19, 2009
(86) PCT No.: PCT/US09/37638

§ 371 Date: Sep. 24, 2010

(30) Foreign Application Priority Data
Mar. 26, 2008 (US) 61/039649

(51) Int. Cl. B05D 3/06; B05D 3/02

(52) U.S. Cl. 427/551; 427/372.2; 427/386; 427/385.5; 427/558; 427/557

(57) ABSTRACT

A method of slide coating that includes providing a first fluid, wherein the first fluid includes at least one solvent, at least one single unit polymeric precursor or a combination thereof; providing a second fluid, wherein the second fluid includes multi unit polymeric precursors; flowing the first fluid down a first slide surface, to create a first fluid layer on the first slide surface, the first slide surface being positioned adjacent a substrate; flowing the second fluid down a second slide surface, the second slide surface positioned relative to the first slide surface such that the second fluid flows from the second slide surface to above the first slide surface onto the first fluid layer to create the second fluid layer on the first slide surface; coating the substrate with the first and second fluid by flowing the first fluid layer and the second fluid layer from the first slide surface to the substrate forming first and second coated layers; moving the substrate; and at least partially curing the first coated layer, the second coated layer, or some combination thereof.

### FIELD

The present disclosure relates to methods of slide coating an article including at least two layers, one of which includes a multi unit polymer precursor.

### BACKGROUND

Slide coating is a method for coating one or more fluid layers on a substrate. The one or more fluids making up the layer precursors flow out of one or more slots that open out onto an inclined plane. The one or more fluids flow down the plane, across the coating gap and onto an upward moving substrate. A number of developments have been reported in this area, but the upper coating speed of slide coating has generally been dictated by the rheology of the polymer solutions that are coated onto the substrate.

### BRIEF SUMMARY

Disclosed herein are methods of slide coating that include providing a first fluid, wherein the first fluid includes at least one solvent, at least one single unit polymeric precursor or a combination thereof; providing a second fluid, wherein the second fluid includes multi unit polymeric precursors, wherein the at least one solvent or the at least one single unit polymeric precursor in the first fluid is compatible with the multi unit polymeric precursor of the second fluid; flowing the first fluid down a first slide surface, to create a first fluid layer on the first slide surface, the first slide surface being positioned adjacent a substrate; flowing the second fluid down a second slide surface, the second slide surface positioned relative to the first slide surface such that the second fluid flows from the second slide surface to above the first slide surface onto the first fluid layer to create the second fluid layer on the first slide surface; coating the substrate with the first and second fluid by flowing the first fluid layer and the second fluid layer from the first slide surface to the substrate; moving the substrate to form first and second coated layers; and curing at least a portion of the first coated layer, the second coated layer, or some combination thereof.

Also disclosed herein are methods of slide coating that include providing a first fluid, wherein the first fluid includes at least one solvent, at least one single unit polymeric precursor, or a combination thereof; providing a second fluid, wherein the second fluid includes multi unit polymeric precursors and single unit polymeric precursors, wherein the at least one solvent or at least one single unit polymeric precursor in the first fluid is compatible with the multi unit polymeric precursors and the single unit polymeric precursors of the second fluid; flowing the first fluid down a first slide surface, to create a first fluid layer on the first slide surface, the first slide surface being positioned adjacent a substrate; flowing the second fluid down a second slide surface, the second slide surface positioned relative to the first slide surface such that the second fluid flows from the second slide surface to above the first slide surface onto the first fluid layer to create the second fluid layer on the first slide surface; coating the substrate with the first and second fluid by flowing the first fluid layer and the second fluid layer from the first slide surface to the substrate forming first and second coated layers; moving the substrate past the first slide surface through use of a backup roll; drying at least a portion of the first coated layer, the second coated layer, or some combination thereof; and curing the first coated layer, the second coated layer, or some combination thereof.

### BRIEF DESCRIPTION OF THE DRAWINGS

The disclosure may be more completely understood in consideration of the following detailed description of various embodiments of the disclosure in connection with the accompanying drawings, in which:

The figures are not necessarily to scale. Like numbers used in the figures refer to like components. However, it will be understood that the use of a number to refer to a component in a given figure is not intended to limit the component in another figure labeled with the same number.

FIG. 1 is a side sectional view of a slide coater that can be used to carry out methods as disclosed herein;

FIG. 2 is a partial top view of the slide coater shown in FIG. 1;

FIG. 3 is a partial side sectional view of the slide coater show in FIG. 1;

FIG. 4 is a partial side sectional view of an embodiment of the slide coater shown in FIG. 1;

FIG. 5 is a partial side sectional view of an embodiment of the slide coater shown in FIG. 1;

FIG. 6 is a schematic view of an embodiment of the slide coater shown in FIG. 1 and additional components; and

FIG. 7 is a partial top view of an embodiment of the slide coater shown in FIG. 1.

### DETAILED DESCRIPTION

Embodiments other than those specifically discussed herein are contemplated and may be made without departing from the scope or spirit of the present disclosure. The following detailed description is not limiting. The definitions provided are to facilitate understanding of certain terms frequently used and do not limit the disclosure.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

The recitation of numerical ranges by endpoints includes all numbers subsumed within that range (e.g., 1 to 5 includes 1, 1.5, 2, 2.75, 3, 3.80, 4, and 5) and any range within that range.

As used in this specification and the appended claims, the singular forms “a”, “an”, and “the” encompass embodiments having plural referents, unless the content clearly dictates otherwise. As used in this specification, use of a singular form of a term, can encompass embodiments including more than one of such term, unless the content clearly dictates otherwise. For example, the phrase “adding a solvent” encompasses adding one solvent, or more than one solvent, unless the content clearly dictates otherwise. As used in this specification and the appended claims, the term “or” is generally employed in its sense including “either or both” unless the context clearly dictates otherwise.

“Include,” “including,” or like terms means encompassing but not limited to, that is, including and not exclusive.

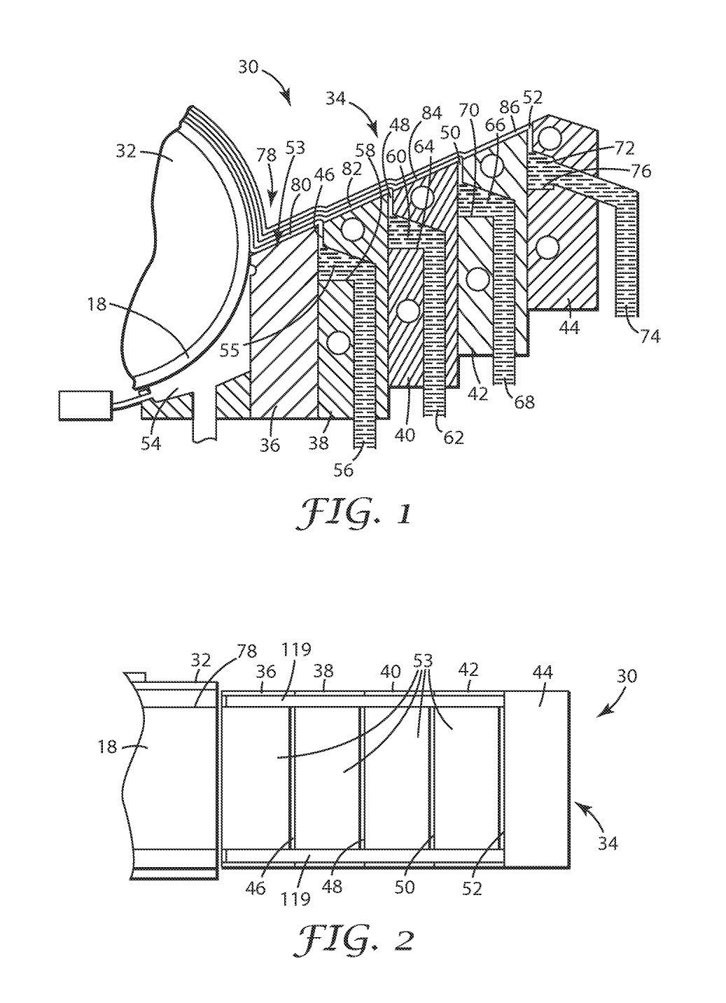

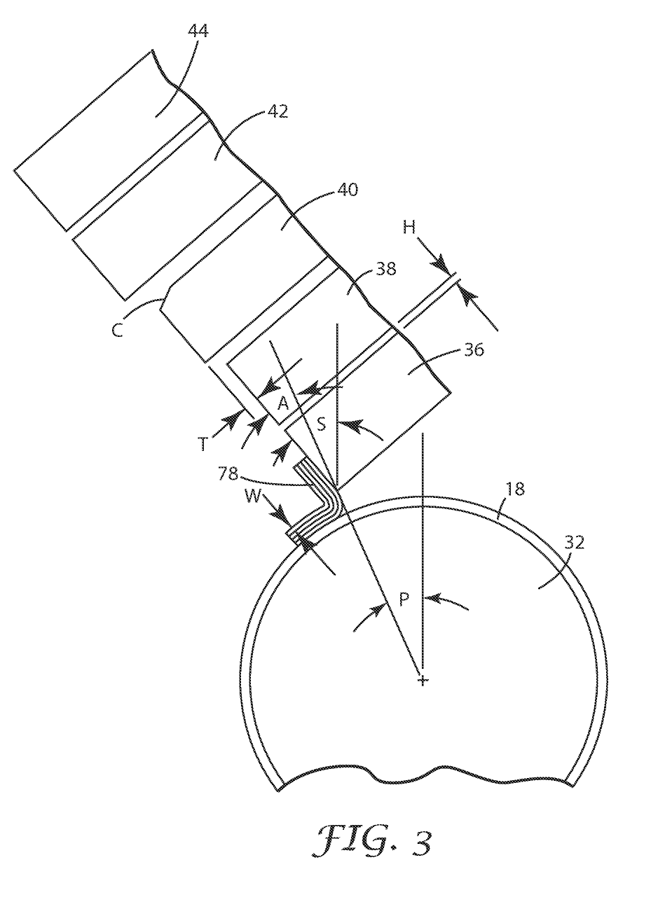

Disclosed herein are methods of slide coating. Methods disclosed herein can generally be carried out on slide coating apparatuses as are generally available and used in the art. FIGS. 1 and 2 illustrate a slide coating apparatus 30 generally made up of a coating back-up roller 32 for the substrate 18, and a slide coater 34. The slide coater 34 includes five slide blocks 36, 38, 40, 42, 44 which define four fluid slots 46, 48, 50, 52 and a slide surface 53. The first slide block 36 is adjacent to the coating back-up roller 32 and includes a vacuum box 54 for adjusting the vacuum level of the slide coating apparatus 30. The vacuum box 54 serves to maintain a differential pressure across the coating bead, thereby stabilizing it.

A first fluid 55 can be distributed to the first slot 46 via a first fluid supply 56 and a first manifold 58. A second fluid 60 can be distributed to the second slot 48 via a second fluid supply 62 and a second manifold 64. A third fluid 66 can be distributed to the third fluid slot 50 via a third fluid supply 68 and a third fluid manifold 70. A fourth fluid 72 can be distributed to the fourth fluid slot 52 via a fourth fluid supply 74 and a fourth fluid manifold 76. This embodiment allows for the creation of up to a four-layer fluid construction 78 including a first fluid layer 80, a second fluid layer 82, a third fluid layer 84, and a fourth fluid layer 86. Additional slide blocks can be added for the introduction of additional fluid layers, as desired for product performance or ease of operability. Similarly, if fewer layers are to be coated, for example coating only two layers, slide blocks can be removed.

The fluid manifolds 58, 64, 70 and 76 are designed to allow uniform width-wise distribution from fluid slots 46, 48, 50, 52, respectively. This design is specific to the choice of slot height H (illustrated in FIG. 3) for the slots 46, 48, 50, 52. The slot height H is made sufficiently small such that the pressure drop in the slot is much higher than the pressure drop across the manifold (without causing undue problems of non-uniformity due to machining limitations or bar deflection due to excessive pressure in the die slot). This can aid in the fluid being distributed uniformly in the slot.

The slide blocks 38, 40, 42, 44 can be configured to have specific slot heights H as depicted in FIG. 3, chosen amongst other reasons to minimize pressure in the die manifolds and to overcome possible problems of non-uniformity due to machining limitations. The slot heights typically used range between about 100-1500 micrometers (μm). The slide blocks 38, 40, 42, 44 can also be arranged with a level offset so as to result in slot steps T, also depicted in FIG. 3. These steps can aid the uniform flow of fluid down the slide surface 53 by minimizing the possibility of flow separation and fluid recirculation zones that can lead to streaking and other product defects. These slot steps can range from about 0-2000 μm in height. Another method of minimizing the occurrence of flow separation on the slide surface 53 is by machining chamfers C on the downstream side of a fluid slot, as depicted in FIG. 3, and could also be used in the embodiment of slide coating as described herein.

In the machining of the slide blocks 36, 38, 40, 42, 44, the finish of the block edges that form the edges of the fluid slots 46, 48, 50, and 52 can be important, as is the front edge of the front block 36 that is adjacent to backup roller 32. The presence of nicks, burrs or other defects on these edges can lead to streaking defects in the product. In order to avoid such defects, the edges can be polished to a finish of less than about 8 microinches (0.02 μm). Details regarding the procedure for finishing the die edges are disclosed in commonly assigned U.S. Pat. No. 5,851,137 and U.S. Pat. No. 5,655,948.

FIG. 3 also illustrates the orientation of the slide coater 34 relative to the back-up roller 32, including the position angle P, attack angle A, and the slide angle S. (The slide angle S is the sum of the position angle P and the attack angle A.) A negative position angle P can generally allow for increased wrap on the back-up roller and thereby greater stability for the coating operation. However, the method could also be used with a zero or positive position angle. The slide angle S at least partially determines the stability of the flow of fluids down the inclined slide plane. A large slide angle S can lead to the development of surface wave instabilities and consequently coating defects. The slide angle can typically be set in the range from slightly greater than zero to about 45°. The distance between the slide coater 34 and the roller 32 at the point of closest approach is known as the coating gap G. The wet thickness W of each layer is the thickness on the surface of the coated substrate 18 substantially far away from the coated bead, but close enough before appreciable drying has occurred.

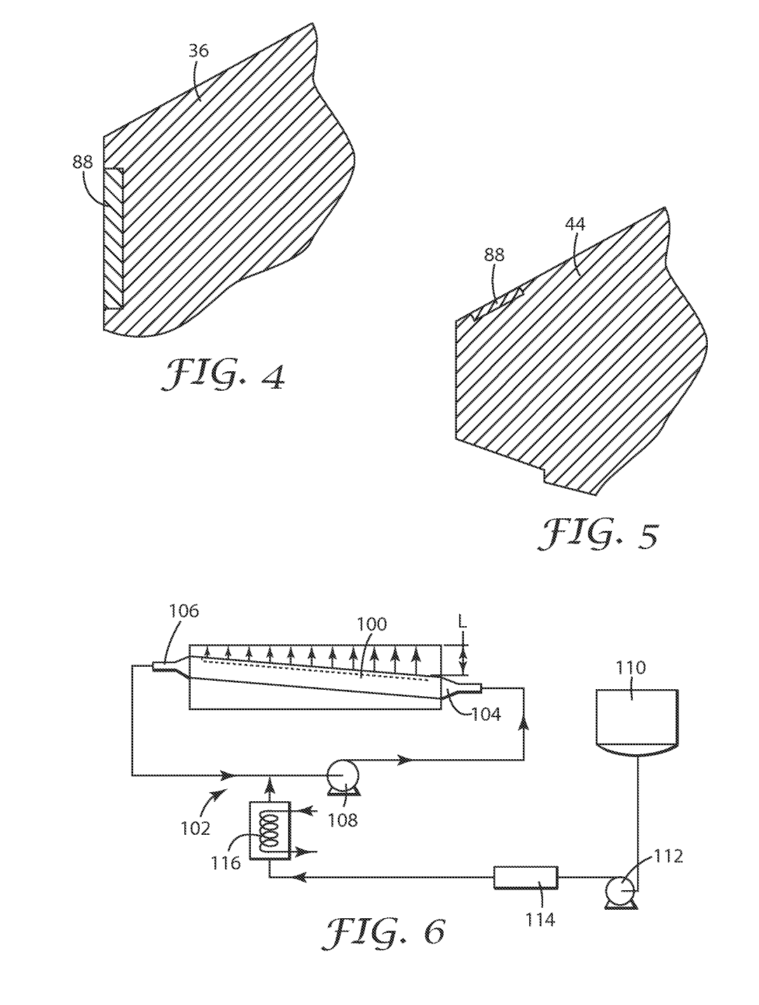

Other portions of the slide coating apparatus 30 deserve further discussion. FIGS. 4 and 5 illustrate portions of the slide coater which include durable, low surface energy portions 88. These portions 88 can provide the desired surface energy properties to specific locations to uniformly pin the coating fluid to prevent build-up of dried material. Details regarding one process of making the durable, low surface energy portions 88 are disclosed in commonly assigned U.S. Pat. No. 5,998,549.

FIG. 6 illustrates a particular type of end-fed manifold 100 and a recirculation loop 102. Note that the manifold 100 is shown as being inclined towards the outlet port 106 such that the depth of the slot L decreases from the inlet port 104 to the outlet port 106. The incline angle can be carefully adjusted to take into account the pressure drop in the fluid as it traverses from the inlet port 104 of the manifold 100 to the outlet port 106 to ensure that the width-wise fluid distribution at the exit of the slot is uniform. With the illustrated manifold design, only a portion of the fluid that enters the manifold 100 leaves through the fluid slot (such as slots 46, 48, 50, or 52), while the remainder flows out through the outlet port 106 to the recirculation loop 102. The portion which flows through the outlet port 106 can be recirculated back to the inlet port 104 by a recirculation pump 108. The recirculation pump 108 can receive fresh fluid from a fluid reservoir 110 and fresh fluid pump 112. A fluid filter 114 and/or heat exchanger 116 can be included to filter and/or heat or cool the fresh fluid before it mixes with the recycled fluid. In this case, the same principles that apply to the design of end-fed manifolds are still applicable. The manifold design, i.e., the cavity shape and angle of incline, however, depends not only on the choice of slot height and fluid rheology, but on the percent recirculation used.

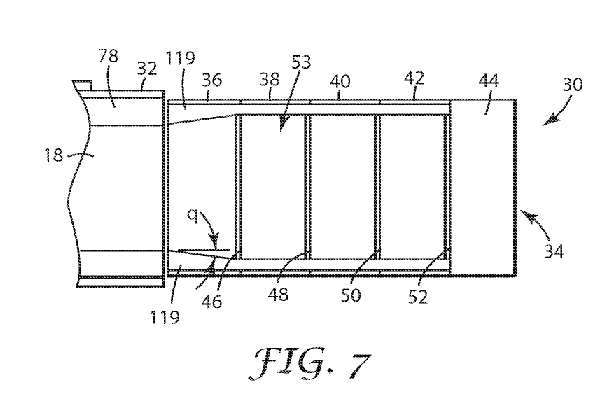

The flow of fluid down the slide surface 53 can be aided by the use of edge guides 119 at each edge of the surface, as shown in FIG. 2 (and FIG. 7). The edge guides 119 can serve to pin the solution to the solid surface and result in a fixed width of coating and also stabilize the flow of fluid at the edges. Note that the edge guides can be straight, and direct flow perpendicular to the slots 46, 48, 50, 52 over the slide surface. The edge guides 119 can be made of one material including metals such as steel, aluminum, etc.; polymers such as polytetrafluoroethylene (e.g., TEFLON®), polyamide (e.g., Nylon), poly(methylene oxide) or polyacetal (e.g., DELRIN®), etc.; wood; ceramic, etc., or can be made of more than one material such as steel coated with polytetrafluoroethylene.

The edge guides 119A can be of a convergent type, as illustrated in FIG. 7. The angle of convergence q can be between about 0 degrees and about 90 degrees, with 0 degrees corresponding to the case of the straight edge guides shown in FIG. 2. The angle q can be chosen for increased stability of the coating bead edges by increasing coating thickness at the bead edges relative to the center. In other embodiments, the edge guides can include durable, low surface energy surfaces or portions as described previously. In addition, the edge guides can be profiled to match the fluid depth profile on the slide surface as described in commonly assigned U.S. Pat. No. 5,837,324.

A cover or shroud over the slide coater 34 can also be used (not shown). An example of such a cover or shroud is described in detail in commonly assigned U.S. Pat. No. 5,725,665.

Methods as disclosed herein generally include steps of providing a first fluid, wherein the first fluid includes at least one solvent, at least one single unit polymeric precursor or a combination thereof; providing a second fluid, wherein the second fluid includes multi unit polymeric precursors, wherein the at least one solvent or at least one single unit polymeric precursor in the first fluid is compatible with the multi unit polymeric precursor of the second fluid; flowing the first fluid down a first slide surface, to create a first fluid layer on the first slide surface, the first slide surface being positioned adjacent a substrate; flowing the second fluid down a second slide surface, the second slide surface positioned relative to the first slide surface such that the second fluid flows from the second slide surface to above the first slide surface onto the first fluid layer to create the second fluid layer on the first slide surface; coating the substrate with the first and second fluid by flowing the first fluid layer and the second fluid layer from the first slide surface to the substrate forming first and second coated layers; moving the substrate; and curing the first coated layer, the second coated layer, or some combination thereof.

Methods as disclosed herein include a step of providing a first fluid. The step of providing a first fluid can be accomplished by obtaining an already prepared first fluid or by preparing a first fluid. Any methods known to one of skill in the art to prepare a solution can be utilized to prepare the first fluid.

Generally, the purpose of the first fluid is to control the viscosity of the entire coated structure (i.e. the first fluid layer and the second fluid layer). The first layer can be considered to serve the function of a carrier layer. Controlling the viscosity of the entire coated structure via the first fluid can afford the advantage of being able to coat a higher viscosity upper layer (the second fluid which would normally not be coatable by slide coating methods), which can reduce drying mottle because the layer will be less susceptible to disturbances. A first fluid can include one or more solvents, one or more single unit polymeric precursors, or combinations thereof. In an embodiment, the first fluid includes one or more solvents. In an embodiment, the first fluid includes one or more single unit polymeric precursors. In an embodiment, the first fluid includes one or more solvents and one or more single unit polymeric precursors.

The at least one solvent, at least one single unit polymeric precursor, or some combination thereof is generally compatible with the multi unit polymeric precursor of the second fluid.

Generally, the viscosity of the first fluid is low enough to both be coated onto the substrate and allow the second fluid to be coated onto the substrate. In an embodiment, the viscosity of the first fluid is not greater than about 5 centipoise (cps). In an embodiment, the viscosity of the first fluid is not greater than about 2 cps. In an embodiment, the viscosity of the first fluid is not greater than about 1 cps.

The first fluid can include one or more than one solvents. In an embodiment, the at least one solvent can be an organic solvent. Generally, the at least one solvent (if present) can be chosen to be compatible with the second fluid, which will eventually exist above it in the coated article. One of skill in the art, given the particular multi unit polymeric precursor (and any other optional components that are included in the second fluid) that is being utilized can generally determine appropriate solvents to be utilized.

Exemplary solvents that can be utilized herein include organic solvents, such as ethyl acetate, propylene glycol methyl ether (commercially available as DOWANOL™ PM from the Dow Chemical Company, Inc. Midland, Mich.), toluene, isopropyl alcohol (IPA), methyl ethyl ketone (MEK), dioxolane, ethanol, and combinations thereof for example. In an embodiment, the second fluid does not contain any more than 10% by weight of water. In an embodiment, the second fluid does not contain any more than 1% by weight of water. In an embodiment, the second fluid is substantially free of water.

The first fluid can also include one or more single unit polymeric precursors. A single unit polymeric precursor is a molecule that once cured, becomes a multi unit polymeric precursor or a polymer. A single unit polymeric precursor includes only one unit that is repeated in the polymer that it forms once cured. A single unit polymeric precursor can be distinguished from a multi unit polymeric precursor because a multi unit polymeric precursor has two or more units that are repeated in the polymer that it forms once cured. Monomers, as that term is commonly used can be considered single unit polymeric precursors.

The single unit polymeric precursor may or may not be the same as those that may optionally be included in the second fluid (discussed below). The single unit polymeric precursors in the first fluid are generally referred to as single unit polymeric precursors or first single unit polymeric precursors. In an embodiment, more than one kind of single unit polymeric precursors can be included in the first fluid. In an embodiment, single unit polymeric precursors that are acrylates can be utilized. In an embodiment, epoxy acrylates, urethane acrylates, carboxylic acid half esters, polyester acrylates, acrylated acrylics, or combinations thereof can be utilized.

Examples of commercially available single unit polymeric precursors that can be utilized include those available from Sartomer Company, Inc. (Exton, Pa.). Specific compounds include, but are not limited to, SR238 1,6 hexanediol diacrylate monomer (Sartomer Company, Inc., Exton, Pa.); SR 355 ditrimethylolpropane tetraacrylate (Sartomer, Exton, Pa.); SR 9003 propoxylated neopentyl glycol diacrylate (Sartomer, Exton, Pa.); Bisomer HEA 2-hydroxy ethyl acrylate (Cognis Corporation, Cincinnati, Ohio); and combinations thereof for example.

In an embodiment, the first fluid can be made up of substantially all or all solvent. Such a first fluid can include one or more than one solvents. In an embodiment, the first fluid can be made up of substantially all or all single unit polymeric precursors. Such a first fluid can include one or more than one single unit polymeric precursors. In an embodiment, a first fluid is made up of both solvent and single unit polymeric precursor.

In a first fluid that includes both solvent (one or more than one solvent) and single unit polymeric precursor (one or more that one single unit polymeric precursor); the amount of the components can be chosen based at least in part, on the viscosity of the ultimate solution. As discussed above, the viscosity of the first fluid can afford the advantage of being able to coat the second layer at a greater thickness. In an embodiment, a first fluid can include at least about 2.2% by weight of a single unit polymeric precursor. In an embodiment, a first fluid can include at least about 4% by weight of a single unit polymeric precursor.

Methods as disclosed herein also include a step of flowing the first fluid down a first slide surface. As discussed above with respect to slide coating apparatuses that can be utilized in methods disclosed herein, a first fluid can be distributed to a first slot via a first fluid supply and a first manifold, after which the first fluid exits the slot and can be flowed down the first slide surface. Also as discussed above, this can generally be accomplished through the design and construction of the slide coating apparatus itself. The first slide surface can generally be positioned adjacent a substrate. The configuration of the first slide surface with respect to the substrate is exemplified in FIG. 1. The rate of and the quantity of the first fluid that can be flowed down the first slide surface can be dictated at least in part by the slot height, H, of the first slot; the viscosity of the first fluid; and the desired coating thickness that is to be obtained on the substrate.

Methods as disclosed herein also include a step of providing a second fluid. The step of providing a second fluid can be accomplished by obtaining an already prepared second fluid or by preparing a second fluid. Any methods known to one of skill in the art to prepare a solution can be utilized to prepare the second fluid.

The second fluid includes multi unit polymeric precursors. A multi unit polymeric precursor is a molecule that once cured, becomes a polymer. A multi unit polymeric precursor can be distinguished from a polymer because a multi unit polymeric precursor still contains reactive groups that can be polymerized. Oligomers, as that term is commonly used can be considered multi unit polymeric precursors. A multi unit polymeric precursor generally includes two or more repeating units of the eventual polymer that is formed there from. In an embodiment, a multi unit polymeric precursor has a number average molecular weight (Mn) of less than about 10,000 g/mol. In an embodiment, a multi unit polymeric precursor has a number average molecular weigh of less than about 8000 g/mol. In an embodiment, a multi unit polymeric precursor has a number average molecular weight of less than about 6000 g/mol. In an embodiment, a multi unit polymeric precursor has a number average molecular weight of less than about 2000 g/mol. In an embodiment, a multi unit polymeric precursor has a number average molecular weight of about 1000 g/mol.

Any multi unit polymeric precursor can be utilized as a component of the second fluid. In an embodiment, more than one kind of multi unit polymeric precursor can be included in the second fluid. In an embodiment, multi unit polymeric precursors that are acrylates can be utilized. In an embodiment, epoxy acrylates, urethane acrylates, carboxylic acid half esters, polyester acrylates, acrylated acrylics, or combinations thereof can be utilized as multi unit polymeric precursors. In an embodiment, urethane acrylates can be utilized as multi unit polymeric precursor in the second fluid.

Examples of commercially available multi unit polymeric precursors that can be utilized include those available from Sartomer Company, Inc. (Exton, Pa.) and the PHOTOMER® and BISOMER® line of products available from Cognis Corporation (Cincinnati, Ohio). Specific compounds include, but are not limited to, Photomer® 6010 aliphatic urethane diacrylate (Cognis Corporation, Cincinnati, Ohio); Photomer® 6210 aliphatic urethane diacrylate (Cognis Corporation, Cincinnati, Ohio); CN 301 polybutadiene dimethacrylate (Sartomer, Exton, Pa.); CN 964 aliphatic polyester based urethane diacrylate (Sartomer, Exton, Pa.); CN 966 aliphatic polyester based urethane diacrylate (Sartomer, Exton, Pa.); CN 981 aliphatic polyester/polyether based urethane diacrylate (Sartomer, Exton, Pa.); CN 982 aliphatic polyester/polyether based urethane diacrylate (Sartomer, Exton, Pa.); CN 985 aliphatic urethane diacrylate (Sartomer, Exton, Pa.); CN 991 aliphatic polyester based urethane diacrylate (Sartomer, Exton, Pa.); CN 9004 difunctional aliphatic urethane acrylate (Sartomer, Exton, Pa.); and combinations thereof for example.

The particular multi unit polymeric precursor or precursors included in any second fluid utilized herein can depend at least in part on the ultimate article that is being made. For example, the particular multi unit polymeric precursor may be chosen because, once cured, it provides enhanced weatherability, enhanced scratch resistance, or other similarly desirable properties. The particular multi unit polymeric precursor or precursors that can be utilized in any second fluid can also depend at least in part on the first fluid on which the second fluid is being coated.

The second fluid may also include other components in addition to the multi unit polymeric precursors. Examples of such other optional components include, but are not limited to single unit polymeric precursors, one or more solvents, optional enhancement additives, initiators, other additives, and combinations thereof for example.

The second fluid may optionally include single unit polymeric precursors. The single unit polymeric precursor may or may not be the same as those that may be included in the first fluid. The single unit polymeric precursors in the second fluid can generally be referred to as second single unit polymeric precursors.

In embodiments where the second fluid includes second single unit polymeric precursors, the second single unit polymeric precursors can be the same or different than the multi unit polymeric precursors in the second fluid or the first single unit polymeric precursors (if present in the second fluid). In an embodiment, more than one kind of single unit polymeric precursors can be included in the second fluid. In an embodiment, single unit polymeric precursors that are acrylates can be utilized. In an embodiment, monofunctional, difunctional, trifunctional, tetrafunctional, higher functionality acrylate monomers, or combinations thereof can be utilized.

Examples of commercially available single unit polymeric precursors that can be utilized as second single unit polymeric precursors include those available from Sartomer Company, Inc. (Exton, Pa.) for example. Specific compounds include SR238 1,6 hexanediol diacrylate monomer (Sartomer Company, Inc., Exton, Pa.); SR 355 ditrimethylolpropane tetraacrylate (Sartomer, Exton, Pa.); SR 9003 propoxylated neopentyl glycol diacrylate (Sartomer, Exton, Pa.); SR 506 isobornyl acrylate (Sartomer, Exton, Pa.); Bisomer HEA 2-hydroxy ethyl acrylate (Cognis Corporation, Cincinnati, Ohio); and combinations thereof for example.

The particular second single unit polymeric precursor or precursors that can optionally be included in any second fluid utilized herein can depend at least in part on the ultimate article that is being made. For example, the particular second single unit polymeric precursor may be chosen because it enhances the crosslinking of the multi unit polymeric precursor, thereby affecting the ultimate physical properties of the cured layer. Similarly, the particular second single unit polymeric precursor may be chosen because it increases the rate at which the multi unit polymeric precursor crosslinks, thereby allowing the entire coating process to be carried out faster.

In an embodiment, the amount of multi unit polymeric precursor and the amount (if any) of second single unit polymeric precursor can affect both the ability to coat the first fluid and the properties of the ultimate coated article. It is thought, but not relied upon that the multi unit polymeric precursors and/or the amount of the multi unit polymeric precursors generally determine at least in part, the ultimate physical properties of the article that is being made; and the second single unit polymeric precursors and/or the amount of the second single unit polymeric precursors determine at least in part, the rate of crosslinking of the coated layer.

The second fluid may optionally include at least one solvent. A solvent that can optionally be included in the second fluid can be referred to as a second solvent. A solvent that can be included in the second fluid can be referred to as a second solvent. In an embodiment, the at least one solvent can be an organic solvent. Generally, the at least one solvent can be chosen to be compatible with the multi unit polymeric precursor and any other optional components of the second fluid. The at least one solvent may also be chosen based, at least in part, on the ease of drying a coated layer containing the solvent. One of skill in the art, given the particular multi unit polymeric precursor (and any other optional components that are included in the second fluid) that is being utilized can generally determine appropriate solvents to be included. The at least one solvent, if included can be a solvent that is in solution with another one of the components (for example, the multi unit polymeric precursor or the second single unit polymeric precursor if included), can be added separately, or a combination thereof (in which case the solvent that is added can be the same solvent or a different solvent than that included in the component).

Exemplary solvents that can be utilized herein include organic solvents, such as ethyl acetate, propylene glycol methyl ether (commercially available as DOWANOL™ PM from the Dow Chemical Company, Inc., Midland, Mich.), toluene, isopropyl alcohol (IPA), methyl ethyl ketone (MEK), dioxolane, ethanol, and combinations thereof for example. In an embodiment, the second fluid does not contain any more than 10% by weight of water. In an embodiment, the second fluid does not contain any more than 1% by weight of water. In an embodiment, the second fluid is substantially free of water. The optional second solvent may be the same as or different than the optional solvent in the first fluid.

The second fluid may also optionally include optical enhancement additives. Optical enhancement additives are generally components that can either make the coating better, thereby creating an optically better product, or can change the optical properties of the coating. One such optical enhancement additive is beads. Beads, for example, can be utilized to provide the coated layer with a matte surface. In an embodiment, the second fluid may optionally include polymeric beads, such as acrylic beads. Examples of polymeric beads that can optionally be utilized herein include acrylic beads, such as polymethyl methacrylate beads commercially available under the trade name MX available from Soken Chemical & Engineering Co., Ltd., Tokyo, Japan; MBX from Sekisui Chemical Co. Ltd; and LDX series from Sunjin Chemical Company (Korea); and acrylic beads from Esprix (Sarasota, Fla.). In an embodiment, the second fluid may optionally include nanoparticles, such as titanium dioxide or silica nanoparticles for example.

The second fluid may also optionally include at least one initiator. Initiators that can be useful include both free-radical thermal initiators and/or photoinitiators. Useful free-radical thermal initiators include azo compounds, peroxide compounds, persulfate compounds, redox initiators, and combinations thereof for example. Useful free-radical photoinitiators include those known as useful in UV curing of acrylate polymers for example. Such initiators include products marketed under the trade name ESACURE® (Lamberti S.p.A., Gallarate (VA) Italy) for example. Combinations of two or more photoinitiators may also be used. Further, sensitizers such as 2-isopropyl thioxanthone, commercially available from First Chemical Corporation, Pascagoula, Miss., may be used in conjunction with photoinitiator(s).

Other optional enhancement additives or other general additives as would be known to one of skill in the art can also be included in the second fluid. An example of such other optional components include surfactants, such as fluorosurfactants for example. Another example of such optional components include slip agents that function to influence the coefficient of friction; an example of a slip agent that could be used is silicone polyether acrylate (i.e., TegoRad 2250, Goldschmidt Chemical Co., Janesville, Wis.).

One of skill in the art will understand that the amount of multi unit polymeric precursors present in the second fluid can depend at least in part on the identity of the multi unit polymeric precursor, the inclusion and identity of optional components that may also be included in the second fluid and the ultimate application and desired properties of the coated article. The second fluid can generally include up to about 60% by weight (based on the total weight of the second fluid before coating) of multi unit polymeric precursors. In an embodiment, the second fluid can generally include up to about 40% by weight (based on the total weight of the second fluid before coating) of multi unit polymeric precursors. In an embodiment, the second fluid can generally include from about 15% to about 20% by weight (based on the total weight of the second fluid before coating) of multi unit polymeric precursors.

In embodiments where the second fluid includes optional second single unit polymeric precursors, the amount of second single unit polymeric precursors present in the second fluid can depend at least in part on the identity of the second single unit polymeric precursor, the inclusion and identity of other optional components and the multi unit polymeric precursors and the ultimate application and desired properties of the coated article. The second fluid can generally include up to about 90% by weight (based on the total weight of the second fluid before coating) of second single unit polymeric precursors. In an embodiment, the second fluid can generally include up to about 50% by weight (based on the total weight of the second fluid before coating) of second single unit polymeric precursors. In an embodiment, the second fluid can generally include from about 2% to about 20% by weight (based on the total weight of the second fluid before coating) of second single unit polymeric precursors.

In embodiments where the second fluid optionally includes at least one solvent, the amount of solvent present in the second fluid can depend at least in part on the identity of the solvent, the inclusion and identity of other optional components and the multi unit polymeric precursors and the ultimate application and desired properties of the coated article. The second fluid can generally include up to about 90% by weight (based on the total weight of the second fluid before coating) of at least one solvent. In an embodiment, the second fluid can generally include up to about 60% by weight (based on the total weight of the second fluid before coating) of at least one solvent. In an embodiment, the second fluid can generally include from about 35% to about 45% by weight (based on the total weight of the second fluid before coating) of at least one solvent.

Other optional components that can be added to the second fluid, such as those discussed above, can be added in amounts as would be known to one of skill in the art based on the identities of the optional components and the reasons why they are being added (i.e. the final desired properties that they are intended to obtain). In an embodiment where beads are added to the second fluid, they can generally be present in the second fluid from about 0.02% to about 40% by weight (based on the total weight of the second fluid before coating. Some of the optional components that may be added to the second fluid may be polymeric in nature (for example, surfactants). However, exemplary second fluids, as utilized herein generally do not contain more than 15% by weight (based on the total weight of the second fluid before coating) of a polymeric component. It should be noted that beads, even if the beads are polymeric beads, are not included in this lower limit of polymeric components. In embodiments that do not contain any polymeric optional components, the second fluid can generally be substantially free of polymer before it is cured. It should be noted that any polymeric components in the second fluid are not necessary, and/or are not added to coat the second fluid and are generally only added to affect other properties.

In an exemplary embodiment, a second fluid can generally include at least multi unit polymeric precursors, second single unit polymeric precursors and at least one second solvent. In an exemplary embodiment, a second fluid can generally include at least multi unit polymeric precursors, second single unit polymeric precursors, at least one second solvent and at least one initiator, for example, a photoinitiator. In an exemplary embodiment, a second fluid can generally include at least multi unit polymeric precursors, second single unit polymeric precursors, at least one second solvent, at least one initiator, and polymeric beads.

In an embodiment, a second fluid can have a viscosity that can enable it to be slide coated along with the first fluid on the substrate. Generally, the ability to coat using slide coating methods as disclosed herein can be dictated in large part by the viscosity of the first fluid. In an embodiment, the viscosity of the second fluid can be at least about 10 times the viscosity of the first fluid. In an embodiment, the viscosity of the second fluid can be at least about 30 times the viscosity of the first fluid. The viscosity of the second fluid can be determined, at least in part, by the viscosity of the multi unit polymeric precursor, the amount of the multi unit polymeric precursor in the second fluid, or a combination thereof. The viscosity of the second fluid can be decreased by either using less of a particular multi unit polymeric precursor, by using a multi unit polymeric precursor with a lower viscosity, or by a combination thereof.

In embodiments that utilize second fluids including optional components such as second single unit polymeric precursors, the viscosity of the second fluid can be determined, at least in part, based on the viscosity of the second single unit polymeric precursor and/or the amount of the second single unit polymeric precursor in the second fluid. The viscosity of the second fluid can be decreased by either using less of a particular second single unit polymeric precursor or by using a second single unit polymeric precursor with a lower viscosity.

The viscosity of a second fluid can also be affected by solvent that may be included in the second fluid. Solvent, when included in the second fluid can have a significant effect on the viscosity of the second fluid. Generally, as the amount of solvent in the second fluid increases, the viscosity of the second fluid generally decreases. Similarly, as solvents with lower viscosity are utilized, the viscosity of the second fluid can be decreased. The viscosity can also be affected by other optional additives that may be included in the first fluid. One of skill in the art would know how such optional additives could affect the viscosity of the fluid and would be able to choose amounts and identities of components to obtain the desired viscosity.

Methods as disclosed herein also include a step of flowing the second fluid down a second slide surface. The second slide surface can be defined by the first slide surface. The second slide surface can generally be positioned relative to the first slide surface such that the second fluid flows from the second slide surface to above the first slide surface onto the first fluid layer to create the second fluid layer on the first slide surface. Generally, the second fluid flows on the first fluid, which is flowing on the slide surface.

Methods as disclosed herein also include a step of coating the substrate with the first fluid and the second fluid by flowing the first fluid layer and the second fluid layer from the slide surface to the substrate. “Slide surface” is used generally to refer to the surface that the first fluid and the second fluid flow down on the apparatus. As discussed above, the first fluid layer and the second fluid layer flow from the slide surface across the coating gap to the substrate in order to form a layer of the first fluid and the second fluid on the substrate. The layer of the first fluid on the substrate can generally be referred to as the first coated layer, and the layer of the second fluid on the first coated layer can generally be referred to as the second coated layer.

As discussed above with respect to slide coating apparatuses that can be utilized in methods disclosed herein, a second fluid can be distributed to a second slot via a second fluid supply and a second manifold, after which the second fluid exits the slot and can be flowed down the second slide surface. Also as discussed above, this can generally be accomplished through the design and construction of the slide coating apparatus itself. The second slide surface with respect to the first slide surface and the substrate is exemplified in FIG. 1. The rate of and quantity of the second fluid flowed down the second slide surface can be dictated at least in part by the slot height, H, of the second slot; the viscosity of the second fluid; and the desired coating thickness that is to be obtained on the first layer.

Generally, slide coating methods involve a trade off between the viscosity of the first fluid and the coating gap of the slide coating apparatus. It can generally be desired to utilize a larger coating gap during a coating process because it can make the coating process smoother and provide better coatings. Generally, as the viscosity is increased, the coating gap can be made smaller; and conversely, coating a fluid with a lower viscosity can be carried out with a larger coating gap. Because coating of the entire coated structure (i.e. the first fluid and the second fluid) is largely dictated by the first coated layer, it is the viscosity of the first fluid that largely dictates the maximum coating gap. Generally, coating methods as disclosed herein can coat using larger coating gaps at higher line speeds than can other coating methods, such as for example, slot die coating. Generally, methods as disclosed herein can coat fluids using coating gaps of about 2 mils or greater (0.002 inches or 50 μm).

A coated layer formed from methods disclosed herein can generally be characterized by the wet thickness of the layer, referred to as Tw. The wet thickness of a coated layer is the thickness of the first fluid on the substrate at a point on the substrate substantially far away from the coated bead but close enough before appreciable drying has occurred. The wet thickness of a second coated layer is the thickness of the second fluid on the first fluid at a point substantially far away from the coated bead but close enough before appreciable drying has occurred. The total wet thickness can also be relevant. The total wet thickness is the total thickness of the first fluid and the second fluid (and any optional additional components) on the substrate at a point substantially far away from the coated bead but close enough before appreciable drying has occurred. In an embodiment, the wet thickness of a single layer or total) can be measured on the substrate about 10 cm away from the coated bead.

Generally, slide coating methods involve a trade off between the minimum wet thickness of the coated layer that can obtain a visually acceptable coating (free of strikethrough and other similar defects) and the speed at which the coating can be carried out. Generally, methods as disclosed herein can be used to coat wet thicknesses as are commonly coated using slide coating methods. Slide coating methods as disclosed herein can generally coat lower minimum wet thicknesses at higher line speeds than other coating methods (such as for example, slot die coating). Generally, lower wet thicknesses can be advantageous because they can be dried quicker with less cosmetic defects such as mottle.

In methods described herein, lower wet thicknesses can advantageously be combined with the ability to coat higher viscosity solutions to obtain relatively high percent solids layers. In an embodiment, methods as disclosed herein can be utilized to coat wet thicknesses of the first fluid of less than or equal to about 10 micrometers. In another embodiment, methods as disclosed herein can be utilized to coat wet thicknesses of the first fluid of less than or equal to about 5 micrometers. The second fluid can generally be coated at about 6 micrometers or greater. In an embodiment, methods as disclosed herein can be utilized to coat wet thicknesses of about 10 micrometers or greater. In an embodiment, methods as disclosed herein can be utilized to coat wet thicknesses of about 20 micrometers or greater even at line speeds of about 1000 feet per minute (5.08 meters per second).

Methods as disclosed herein also include a step of moving the substrate. In an embodiment, the substrate is moved through the use of a coating backup roller (an example of which can be seen in FIG. 1). Generally, the backup roller brings the substrate adjacent to the slide surface, where it is coated with the first fluid and the second fluid, and then carries the coated substrate away from the slide surface. The backup roller is generally configured within the slide coating apparatus in order to carry the coated substrate away from the slide surface in order to allow further step(s) of the method to be carried out. Generally, methods as disclosed herein can include moving the substrate past the slide surface (to be coated) at speeds (referred to herein as line speeds) as generally utilized in slide coating. In an embodiment, methods as disclosed herein can include utilizing line speeds of about 100 feet per minute (0.508 meters per second) or greater while still obtaining a visually acceptable coating. In an embodiment, methods as disclosed herein can include utilizing line speeds of about 200 feet per minute (1.016 meters per second) or greater while still obtaining a visually acceptable coating. In an embodiment, methods as disclosed herein can include utilizing line speeds of about 1000 feet per minute (5.08 meters per second) or greater while still obtaining a visually acceptable coating.

Methods as disclosed herein can be utilized to coat any substrates commonly or desired to be coated with known coating methods. Examples include polyethylene (PET) films, polyester films, polypropylene, triacetate cellulose (TAC), paper and polycarbonate for example. The choice of substrate can be made, at least in part, based on the final application and the final desired properties of the article.

Methods as disclosed herein also include a step of curing the coated layers or curing the first coated layer, the second coated layer or some combination thereof. Curing the coated layer can include partial curing of the first coated layer, the second coated layer, or a combination thereof; or complete curing of the first coated layer, the second coated layer, or a combination thereof; or partial and/or complete curing of the first coated layer, partial and/or complete curing of the second coated layer, or some combination thereof. The step of curing can generally be accomplished as is commonly known to one of skill in the art, including utilizing a source of ultraviolet radiation, a source of infrared radiation, a source of x-rays, a source of gamma-rays, a source of visible light, a source of microwaves, an electron beam source, heat, or combinations thereof for example. In embodiments that include curing though the use of heat, an oven capable of thermally curing the first fluid can be utilized.

The method can also optionally include a step of drying at least a portion of the first fluid, the second fluid, or a combination thereof on the substrate before it is cured. The step of drying generally includes evaporation of at least a portion of the solvent that may be present within the first fluid, the second fluid, or both. The step of drying need not, but can evaporate all of the solvent that is present in either or both of the first and second fluids once coated. Drying can be accomplished based entirely on the ambient conditions that are present where the coating method is taking place, or can be controlled (either hastened or slowed down) by controlling the conditions of drying. For example, the temperature can be increased through the use of a drying oven in order to hasten the drying of the first fluid, the second fluid, or a combination thereof. Similarly, other environmental conditions can also be affected to hasten and/or control the drying of the first fluid, the second fluid or a combination thereof. Such drying conditions are known to those of skill in the art. The step of drying can also continue during the curing step.

An exemplary method as disclosed herein includes providing a first fluid, wherein the first fluid includes at least one solvent, at least one single unit polymeric precursor, or a combination thereof; providing a second fluid, wherein the second fluid includes multi unit polymeric precursors and second single unit polymeric precursors, wherein the at least one solvent in the first fluid is compatible with the multi unit polymeric precursors and the second single unit polymeric precursors of the second fluid; flowing the first fluid down a first slide surface, to create a first fluid layer on the first slide surface, the first slide surface being positioned adjacent a substrate; flowing the second fluid down a second slide surface, the second slide surface positioned relative to the first slide surface such that the second fluid flows from the second slide surface to above the first slide surface onto the first fluid layer to create the second fluid layer on the first slide surface; coating the substrate with the first and second fluid by flowing the first fluid layer and the second fluid layer from the first slide surface to the substrate forming first and second coated layers; moving the substrate past the first slide surface through use of a roll; drying at least a portion of the first fluid, the second fluid, or some combination thereof; and curing at least a portion of the first coated layer, the second coated layer, or some combination thereof.

Methods as disclosed herein can also include coating subsequent layers on top of the first coated layer and the second coated layer. One of skill in the art will know, having read this specification, how to carry out the coating of such subsequent layers. The subsequent fluids that are to be coated may be similar to, or different from the first fluid, the second fluid, or both.

### EXAMPLES

### Example 1

This example was carried out in order to examine the effect of the oligomer chain length and the amount of oligomer in solution at the time of coating. The slide coating machine was set up to coat two layers with the first slot at a height of 100 μm and a stop height of 50 μm; the second slot at a height of 1000 μm and a step height of 250 μm. The slide and position angles were 25 degrees and −10 degrees, respectively. The front nose was a ski-jump (an example of which can be found in U.S. Pat. No. 3,993,019). The line speed was set at 2 meters per second.

The first fluid included 4% by weight of SR 9003 (Sartomer, Exton, Pa.) in toluene (the viscosity of the fluid was 0.6 cps). The second fluid had variable amounts of oligomer and monomer, but each formulation included 45.9% by weight of total solids; and the amount of oligomer+monomer accounted for 17.6% by weight of the total solution. The monomer in all of the formulations was SR 9003 (Sartomer Company, Inc., Exton, Pa.). The oligomer was changed as seen in Table I below. All oligomers used in this Example are commercially available under the trade name given in Table I from Cognis Corporation (Cincinnati, Ohio). Each of the formulations also included 48.7% by weight of toluene, 5.4% by weight of isopropyl alcohol, 0.6% by weight of Esacure One (Lamberti S.p.A., Gallarate (VA) Italy), and 27.6% by weight of MBX-8 beads from Sekisui Chemical Co. Ltd (Japan).

The ratio of the oligomer to the monomer (by weight) was set to three levels (see Table I below) for each oligomer. The second layer wet thickness was run at two levels for comparison. The first layer wet thickness was adjusted to the minimum level that provided for good coating quality. The coating gap and vacuum level were adjusted to obtain the best coating quality of the two layers. The solution was coated on a 2 mil MELINEX® 617 PET film (Dupont Teijin Films U.S. Limited Partnership, Hopewell, Va.). The results can be seen in Table I below. The oligomer viscosity is approximately proportional to its molecular weight. The second layer solution viscosity increases with oligomer:monomer ratio and also with the viscosity of the oligomer. The coating window improves as the second layer solution viscosity increases. This is demonstrated by the ability to obtain good coating quality with minimum carrier (first layer) wet thickness and/or lower topcoat wet thickness (second layer). Decreased wet thickness, in either layer, has the advantages of lower cost and more uniform cosmetic quality during the drying phase.

TABLE I

| | Oligomer | | | | | | | |
|---|---|---|---|---|---|---|---|---|
| | Viscosity | | Solution | Topcoat | Minimum | Coating | Vacuum | Condition |
| | @60° C. | Oligomer: | viscosity | Tw | Carrier | Gap | (mm | of |
| Oligomer | (cps) | Monomer | (cps) | (μm) | Tw (μm) | (μm) | WC) | coating |
| CN 985 | 205 | 1:1 | 2.29 | 22 | 13 | 75 | 8 | ribbing |
| | | 1:1 | | 27 | 13 | 75 | 20 | good |
| | | 2:1 | 2.73 | 22 | 13 | 75 | 10 | ribbing |
| | | 2:1 | | 27 | 13 | 75 | 16 | good |
| | | 100:0 | 3.04 | 22 | 12 | 75 | 20 | ribbing |
| | | 100:0 | | 27 | 12 | 100 | 40 | good |
| CN 991 | 660 | 1:1 | 3.64 | 22 | 12 | 75 | 20 | ribbing |
| | | 1:1 | | 27 | 12 | 100 | 33 | good |
| | | 2:1 | 4.44 | 22 | 12 | 75 | 20 | ribbing |
| | | 2:1 | | 27 | 12 | 100 | 33 | good |
| | | 100:0 | 5.64 | 22 | 11 | 100 | 32 | good |
| | | 100:0 | | 27 | 10 | 100 | 32 | good |
| CN 981 | 6190 | 1:1 | 3.82 | 22 | 12 | 100 | 33 | ribbing |
| | | 1:1 | | 27 | 12 | 100 | 24 | good |
| | | 2:1 | 4.42 | 22 | 12 | 100 | 22 | good |
| | | 2:1 | | 27 | 11 | 100 | 22 | good |
| | | 100:0 | 10.36 | 22 | 10 | 100 | 26 | good |
| | | 100:0 | | 27 | 9 | 100 | 26 | good |
| CN 9004 | 21000 | 1:1 | 19.26 | 22 | 4 | 100 | 26 | good |
| | | 1:1 | | 27 | 4 | 100 | 26 | good |
| | | 2:1 | 117.2 | 22 | 1 | 100 | 26 | good |
| | | 2:1 | | 27 | 1 | 100 | 26 | good |
| CN 6010 | 5800 | 1:1 | 6.67 | 22 | 10 | 100 | 26 | good |
| | | 1:1 | | 27 | 10 | 100 | 26 | good |
| | | 2:1 | 9.84 | 22 | 6 | 100 | 26 | good |
| | | 2:1 | | 27 | 6 | 100 | 26 | good |
| | | 100:0 | 19.95 | 22 | 5 | 100 | 13 | good |
| | | 100:0 | | 27 | 4 | 100 | 16 | good |

Note:
The viscosities were measured at 23 degrees C. with a Brookfield viscometer with UL adaptor.

### Example 2

Example 1 demonstrated multi-layer coating without the use of any polymers. It was observed in that example that as viscosity increased in the second layer the coating window also increased. This example was run to show that a very small amount of polymer could be used to increase the second layer viscosity and also improve the coating window. The coating window was determined by the minimum first layer (or carrier) flow rate necessary to establish good coating quality. The second layer viscosity, second layer wet thickness, and coating speed was varied.

The first fluid was 100% ethyl acetate. The second fluid included various ratios by weight of a solution referred to herein as “PETA” and a solution referred to herein as “CAB”. The PETA solution was a photopolymerizable dispersion with solids consisting mainly of 51% by weight pentaerythritoltriacrylate (“SR-444” from Sartomer Company, Inc. of Exton, Pa.) and 37% by weight reaction product of colloidal silica (“Nalco 2327” from Nalco Company of Naperville, Ill.) and 3-trimethoxysilylpropyl methacrylate (“A174” from Momentive Performance Materials of Wilton, Conn.). Other solid additives were 8% by weight n,n-dimethylacrylamide (“NNDMA” from Sigma-Aldrich Company of St. Louis, Mo.), 2.4% by weight 1-hydroxy-cyclohexyl-phenylketone (“Irgacure 184 from Ciba Specialty Chemicals of Newport, Del.), 2% by weight bis (pentamethyl-1,2,2,6,6 piperidinyl-4) decanoate (“Tinuvin 292” from Ciba Specialty Chemicals of Newport, Del.), 50 ppm phenothiazine (Cytec Industries, Inc. of West Patterson, N.J.) and 400 ppm 2,6-di-tert-butyl-p-cresol (Merisol USA, LLC of Houston, Tex.). The CAB solution was a 10% by weight solution of cellulose acetate butyrate (CAB 381-20 from Eastman Chemical Co., Kingsport, Tenn.) dissolved in ethyl acetate. The amounts of PETA and CAB making up the various solutions tested and their final viscosities can be seen in Table II below. The solution was coated on a 2 mil MELINEX® 617 PET film (Dupont Teijin Films U.S. Limited Partnership, Hopewell, Va.).

TABLE II

| | | | |
|---|---|---|---|
| Solution | Solution Blend | CAB % of | Viscosity, |

| Number | % PETA | % CAB | Total Solids | (cps) |
|---|---|---|---|---|
| 1 | 100 | 0 | 0 | 11 |
| 2 | 97 | 3 | 0.6 | 31 |
| 3 | 93 | 7 | 1.5 | 68 |
| 4 | 88 | 12 | 2.7 | 166 |
| 5 | 71 | 29 | 7.6 | 300 |

The slide coating machine was set up with a first slot height at 75 μm and a first step height of 50 μm; a second slot height of 380 μm and a second step height of 380 μm. The attack angle and position angle were 25° and −10° respectively. The front nose was a ski-jump. The edge guides were straight. The coating gap was set at 100 μm. The results can be seen in Table III below.

TABLE III

| | | Second | | | |
|---|---|---|---|---|---|
| | Line | Solution | | Second | First Layer |
| Solution | Speed | Viscosity | Vacuum | Layer Tw | Minimum Tw |
| Number | (m/sec) | (cps) | (mm H₂O) | (μm) | (μm) |
| 1* | 1 | 11 | 18 | 23 | 2.8 |
| | 1.5 | 11 | 25 | 23 | 2.5 |
| | 2 | 11 | 13 | 23 | 3.1 |
| | 2.5 | 11 | 36 | 23 | 4.3 |
| 2 | 1 | 31 | | 14 | No window |
| | 1.5 | 31 | 41 | 14 | 2.7 |
| | 2 | 31 | 43 | 14 | 3.2 |
| | 2.5 | 31 | 38 | 14 | 3.4 |
| 3 | 1 | 68 | 9 | 14 | 2.2 |
| | 1.5 | 68 | 18 | 14 | 1.7 |
| | 2 | 68 | 28 | 14 | 2.1 |
| | 2.5 | 68 | 53 | 14 | 3.9 |
| 4 | 1 | 166 | 3 | 14 | 4.2 |
| | 1.5 | 166 | 15 | 14 | 3.5 |
| | 2 | 166 | 13 | 14 | 3.2 |
| | 2.5 | 166 | 20 | 14 | 3.0 |
| 5 | 1 | 300 | 9 | 14 | 4.2 |
| | 1.5 | 300 | 9 | 14 | 4.4 |
| | 2 | 300 | 9 | 14 | 4.3 |
| | 2.5 | 300 | 9 | 14 | 4.3 |

*Solution 1 could not be coated below 20 microns wet thickness.

The results show that increasing the viscosity of the second layer enables coating that layer at a lower wet thickness. A very small amount of polymer is required to achieve the performance improvement. The amount required will depend on the polymer chosen.

Thus, embodiments of methods of slide coating two or more fluids are disclosed. One skilled in the art will appreciate that the present disclosure can be practiced with embodiments other than those disclosed. The disclosed embodiments are presented for purposes of illustration and not limitation, and the present disclosure is limited only by the claims that follow.

1. A method of slide coating comprising:
providing a first fluid, wherein the first fluid comprises at least one solvent, at least one single unit polymeric precursor, or a combination thereof;
providing a second fluid, wherein the second fluid comprises second multi unit polymeric precursors, wherein the at least one solvent or the at least one single unit polymeric precursor in the first fluid is compatible with the multi unit polymeric precursor of the second fluid;
flowing the first fluid down a first slide surface, to create a first fluid layer on the first slide surface, the first slide surface being positioned adjacent a substrate;
flowing the second fluid down a second slide surface, the second slide surface positioned relative to the first slide surface such that the second fluid flows from the second slide surface to above the first slide surface onto the first fluid layer to create the second fluid layer on the first slide surface;
coating the substrate with the first and second fluid by flowing the first fluid layer and the second fluid layer from the first slide surface to the substrate forming first and second coated layers;
moving the substrate; and
curing at least a portion of the first coated layer, the second coated layer, or some combination thereof.

2. The method according to claim 1, wherein the first fluid comprises at least one solvent and at least one single unit polymeric precursor.

3. The method according to claim 2, wherein the first fluid has a viscosity of about 5 centipoise or less.

4. The method according to claim 1, wherein the first fluid is coated onto the substrate at a thickness of about 10 micrometers or less.

5. The method according to claim 1, wherein the second fluid further comprises second single unit polymeric precursors.

6. The method according to claim 5, wherein the second fluid further comprises at least one second solvent.

7. The method according to claim 6, wherein the second fluid comprises not greater than about 10% by weight of water.

8. The method according to claim 1, wherein the multi unit polymeric precursors are acrylates selected from the group consisting of epoxy acrylates, urethane acrylates, carboxylic acid half esters, polyester acrylates, acrylated acrylics, or combinations thereof.

9. (canceled)

10. The method according to claim 1, wherein the second fluid does not have more than about 15% by weight of polymer based on total weight of the second fluid before coating.

11. The method according to claim 1, wherein the viscosity of the second fluid is at least about 10 times the viscosity of the first fluid.

12. The method according to claim 11, wherein the second fluid further comprises beads.

13. The method according to claim 12, wherein the second fluid is coated onto the substrate at a thickness of about 10 microns or thicker.

14. The method according to claim 1, further comprising drying at least a portion of the first fluid, the second fluid, or some combination thereof before curing.

15. The method according to claim 1, wherein curing is accomplished using a source of ultraviolet radiation, a source of infrared radiation, a source of x-rays, a source of gamma-rays, a source of visible light, a source of microwaves, an electron beam source, heat, or combinations thereof.

16. The method according to claim 15, wherein the substrate is moved at a speed of at least about 0.5 meters per second.

17-22. (canceled)
